(19) United States
(12) Patent Application Publication
(10) Pub. No.: US 2007/0121458 A1
(43) Pub. Date: May 31, 2007

(54) SYNCHRONICITY DETERMINING DEVICE, AND PHYSICAL ADDRESS DETECTING DEVICE AND METHOD

(76) Inventor: Satoru KOJIMA, Kawaguchi-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/552,611

(22) Filed: Oct. 25, 2006

(30) Foreign Application Priority Data
Nov. 29, 2005 (JP) 2005-343966

(51) Int. Cl. G11B 27/36

(52) U.S. Cl. 369/53.34

(57) ABSTRACT

According to one embodiment, a synchronicity detecting circuit to which a wobble signal reproduced from a recording track is input and which detects a synchronizing signal in the wobble signal, a synchronicity detection flag generating section which generates a synchronicity detection flag of a first level when the synchronicity detecting circuit detects the synchronizing signal, and a counter and logic determining section which resets the synchronicity detection flag to a second level when the output synchronicity detection flag of the first level remains active and when the number of non-detections of the synchronizing signal meets a predetermined condition. A physical address is thus detected when the synchronicity detection flag is at the first level.

### CROSS-REFERENCE TO RELATED APPLICATIONS

This application is based upon and claims the benefit of priority from Japanese Patent Application No. 2005-343966, filed Nov. 29, 2005, the entire contents of which are incorporated herein by reference.

### BACKGROUND

1. Field

One embodiment of the invention relates to a synchronicity determining device and a physical address detecting device and method which are effectively used for an optical disk apparatus.

2. Description of the Related Art

DVDs (Digital Versatile Discs) have recently prevailed widely as digital recording media. Rewritable DVDs employ a wobble modulating scheme as a method for recording physical addresses on recording tracks. This scheme records address information or the like by forming meandering grooves constituting recording tracks so as to invert or non-invert the phases of wobbles.

The next-generation DVD standards specify a physical address format. Recording/reproducing apparatuses utilize the characteristics of this format to recognize physical addresses. To recognize a physical address, it is necessary to detect a synchronizing signal and then to understand various data on the basis of the synchronizing signal. Thus, an operation of detecting the synchronizing signal is important. The synchronizing signal has been desired to be accurately detected.

Documents that disclose a technique for detecting the synchronizing signal include US 2004/0179445 A1 and US 2005/0141374 A1. US 2004/0179445 A1 discloses a technique that unlocks a synchronizing lock flag when an even-numbered synchronizing pattern is detected in an odd-numbered synchronizing pattern detection window. When the synchronizing lock flag remains locked for 16 sectors, a detection period counter is synchronized to a recording period counter. US 2005/0141374 A1 discloses a technique that uses, as an effective synchronicity detection signal, a phase edge of address information appearing at a fixed period and a synchronicity detection signal that is timely output at a fixed period, the phase edge and synchronicity detection signal being in synchronism with each other.

Even if the synchronicity detecting circuit accurately detects a synchronizing signal, it cannot always consecutively accurately detect the next synchronizing signal for the succeeding period. In this case, the periodicity of the synchronizing signal is usually utilized to allow a flywheel counter to count clocks. Thus, a false synchronizing signal is output at a timing when the next synchronizing signal is expected to be obtained. However, the false synchronizing signal is not endlessly output, and if it is continuously generated for a predetermined period of time, this state is determined to be asynchronous.

However, the conventional method uniquely determines the period when the false synchronizing signal is to be used. This may result in too early an asynchronicity determination (or the period when synchronicity is continuously determined is too short) or too late an asynchronicity determination (or the period when synchronicity is continuously determined is too long).

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing the configuration of the whole information recording and reproducing apparatus to which the present invention is applied;

FIG. 2 is a diagram illustrating a method for addressing an optical disk in which recording tracks are subjected to wobble modulation;

FIG. 3 is a diagram illustrating an HD DVD-R physical address format;

FIG. 4 is a diagram showing an example in which two types of WDU configurations (physical segment types), primary segments and secondary segments, are provided;

FIG. 5 is a block diagram showing the internal configuration of a physical address detecting device 5 according to the present invention;

FIG. 6 is a diagram showing an exemplary principle configuration of a SYNC detecting circuit;

FIG. 7 is a diagram of a further embodied configuration of the SYNC detecting circuit;

FIG. 8 is a diagram illustrating operation timings for each section of the SYNC detecting circuit;

FIG. 9 is a diagram showing an exemplary configuration of a physical address head detecting section;

FIG. 10 is a diagram specifically showing the configuration of a SYNC detection flag circuit;

FIG. 11 is a timing chart showing an exemplary operation of a device according to the present invention;

FIG. 12 is a timing chart showing another exemplary operation of the device according to the present invention;

FIG. 13 is a timing chart showing another exemplary operation of the device according to the present invention;

FIG. 14 is a timing chart showing another exemplary operation of the device according to the present invention; and

FIG. 15 is a timing chart showing a further exemplary operation of the device according to the present invention.

### DETAILED DESCRIPTION

Various embodiments according to the invention will be described hereinafter with reference to the accompanying drawings.

The embodiments associate a SYNC detection flag that is generated together with the first synchronizing signal detected, with a subsequently actually detected synchronizing signal to make conditions for determining asynchronicity variable. An object of the embodiments is thus to provide a synchronicity determining device and a physical address detecting device and method which enable synchronicity determinations to be stabilized.

Another object of the embodiments is to provide a physical address detecting device and method which utilizes the SYNC detection flag as an enable for physical address extraction to accurately extract physical addresses.

According to an embodiment of the present invention, a format of information incorporated into information recording media by subjecting recording tracks in the information recording media to wobble modulation has at least physical segments, each of which into is partitioned recording tracks, a wobble data unit (WDU) for a synchronizing signal which is contained in a head of the physical segments, a wobble data unit (WDU) for a non-modulation section which is contained in a latter half of the physical segments, and a wobble data unit (WDU) for a physical address which is contained in an intermediate area of the physical segments. A synchronicity determining device comprises a synchronicity detecting circuit to which a wobble signal reproduced from the recording track is input and which detects the synchronizing signal in the wobble signal, a synchronicity detection flag generating circuit which generates a synchronicity detection flag of a first level when the synchronicity detecting circuit detects the synchronizing signal, and a counter and logic determining section which resets the synchronicity detection flag to a second level when the output synchronicity detection flag of the first level remains active and when the number of non-detections of the synchronizing signal meets a predetermined condition.

The above means associates the SYNC detection flag that is generated together with the first synchronizing signal detected, with the subsequently actually detected synchronizing signal to make the conditions for determining asynchronicity variable. This enables synchronicity determinations to be stabilized.

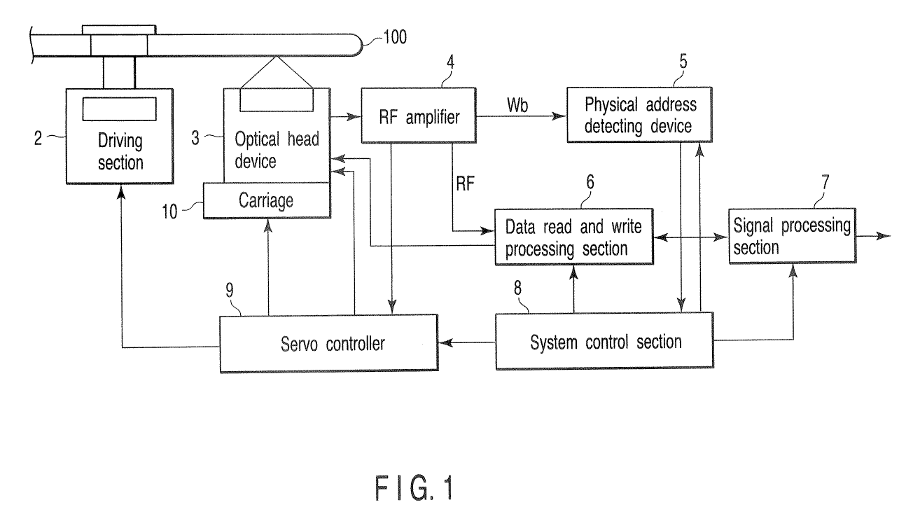

The embodiments of the present invention will be described with reference to the drawings. FIG. 1 is a diagram schematically showing the general configuration of an optical disk apparatus to which the present invention is applied. The optical disk apparatus is provided with a driving section 2 that rotationally drives an optical disk 100 and an optical head device 3 that reads information recorded on the optical disk 100 and that writes information to the optical disk 100. The optical disk apparatus is also provided with an RF amplifier 4. The RF amplifier 4 generates a wobble signal Wd containing a physical address in a recording track in the optical disk 100 and supplies the wobble signal Wd to a physical address detecting device 5. The RF amplifier 4 also supplies a data read and write processing section 6 with an RF signal containing user data recorded in the optical disk 100. The data read and write processing section 6 can supply a signal that is written to the optical disk 100, to a laser driving circuit (not shown) in an optical head device 3. An output signal from the data read and write processing section 6 is input to a signal processing section 7, which then decodes the signal. To be written to the optical disk 100, a signal is formatted by the signal processing section 7 and supplied to the data read and write processing section 6.

A system control section 8 controls each of the other sections. A servo controller 9 detects a focus error and a tracking error in the optical head device 3 on the basis of an RF signal. The optical head device 3 accurately controls an actuator so that a focus on operation and a track on operation are accurately performed on recording tracks. A carriage 10 is controlled to regulate the radial position of the optical head device 3. The driving section 2 is controlled to stabilize disk rotations.

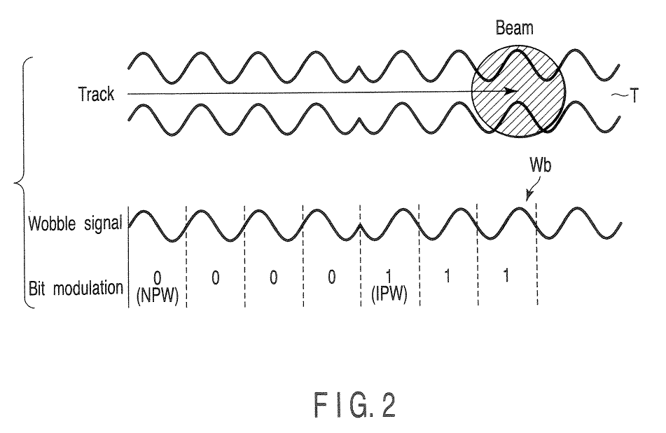

FIG. 2 shows a method for addressing the optical disk 100 in which recording tracks are subjected to wobble modulation. The figure shows the relationship between a wobble signal and a bit modulation state. An output beam from the optical head device 3 traces a meandering recording track T. This allows digital data to be reproduced from the recording track T (or allows digital data to be recorded in the recording track T). The recorded data is recorded at a specified position. Physical address information having determined the recorded position is obtained by reading and demodulating a wobble signal Wb from the recording track T.

Description will be given of a read beam on the track, the detected wobble signal Wb, and modulation rules for embedding information on the basis of wobble modulation. The sign wave of the wobble signal (NPW) is used as bit modulation data “0”. The inverted sign wave (IPW) is used as bit modulation data “1”.

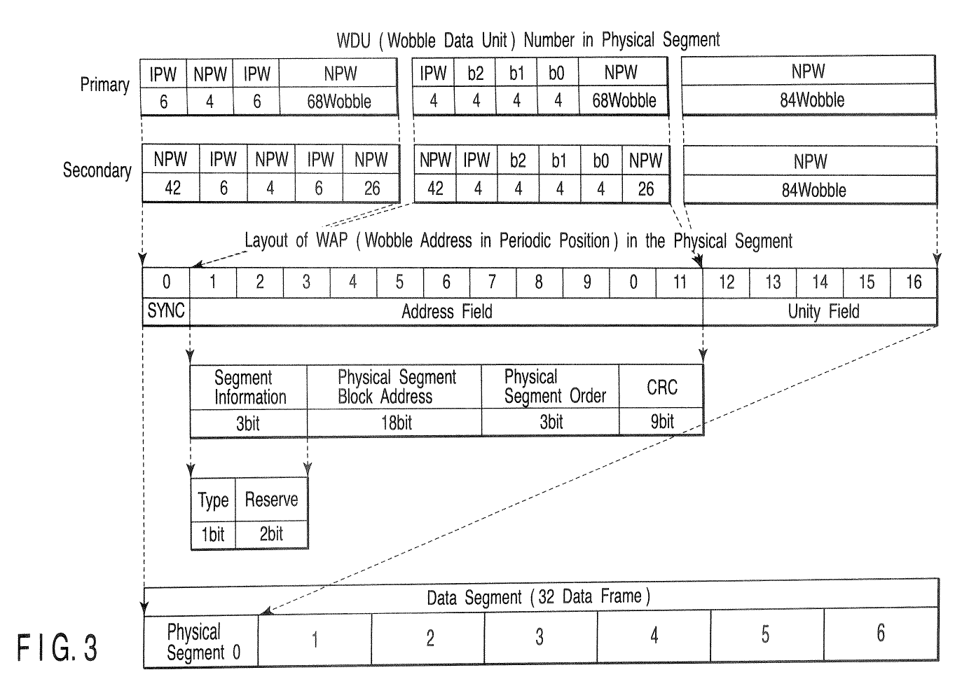

FIG. 3 shows an HD DVD-R physical address format that is composed of the bit modulation data NPW (=“0”) and IPW (=“1”) in the wobble signal in FIG. 2.

Physical address data is stored in a physical address field. The physical address data is composed of 33 bits, including 3 bits of segment information, 18 bits for a physical segment block address, 3 bits for a physical segment order, and 9 bits for an error correction code (CRC).

The 33-bit physical address data is divided into 3-bit groups that are distributed to WDUs (Wobble Data Units). Each WDU then modulates and embeds the data in optical disk recording media.

Thus, the 33 physical address data bits are composed of 11 WDUs. Four wobbles correspond to 1 physical address data bit of each WDU. Accordingly, 3 bits are represented by 4×3=12 wobbles. WDUs include a primary type and a secondary type.

For the primary segment type, the 4 leading wobbles of each WDU preceding 3 physical address bit information are composed of IPW to facilitate identification of the head of each WDU. One WDU is composed of 84 wobbles. Thus, 68 wobbles following embedded physical address data are specified to be NPW.

In contrast, for the secondary segment type, the WDU head identification and the configuration of the 3 physical address data bits are similar to those for the primary segment type. However, NPW of 42 wobbles precedes the WDU head identification and 26 wobbles following the embedded physical address data are specified to be NPW. The primary and secondary segment types can be distinguished from each other on the basis of contents of 3 bits of segment information.

For physical address data, one address is composed of a set called WAP (Wobble Address Periodic position) composed of 17 WDUs. One WAP is composed of a SYNC (synchronizing signal) located in a leading WDU, a physical address located in succeeding 11 WDUs, a non-modulation field (unity field) located in succeeding 5 WDUs.

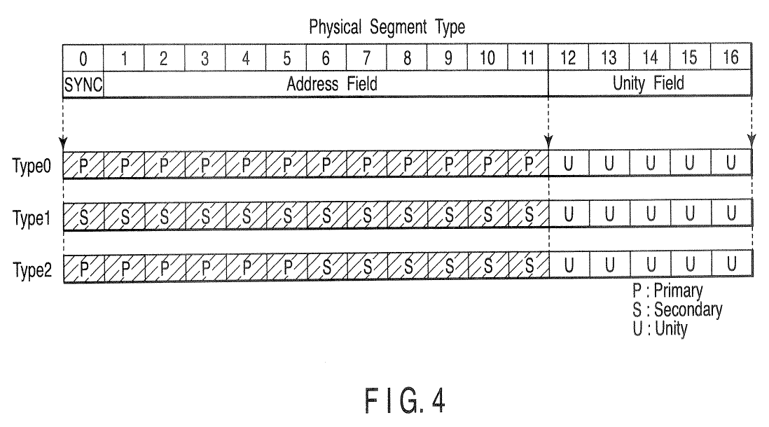

FIG. 4 shows an example in which two types of WDU configurations (physical segment types), primary segments and secondary segments, are provided in order to reduce noise caused by adjacent wobble modulation areas in different tracks.

The WDU configuration can be identified by a type bit in segment information shown in FIG. 3. Type=0 indicates Type 0 (primary segment type), and Type=1 indicates Type 1 (secondary segment type) or Type 2 (primary segment type+secondary segment type).

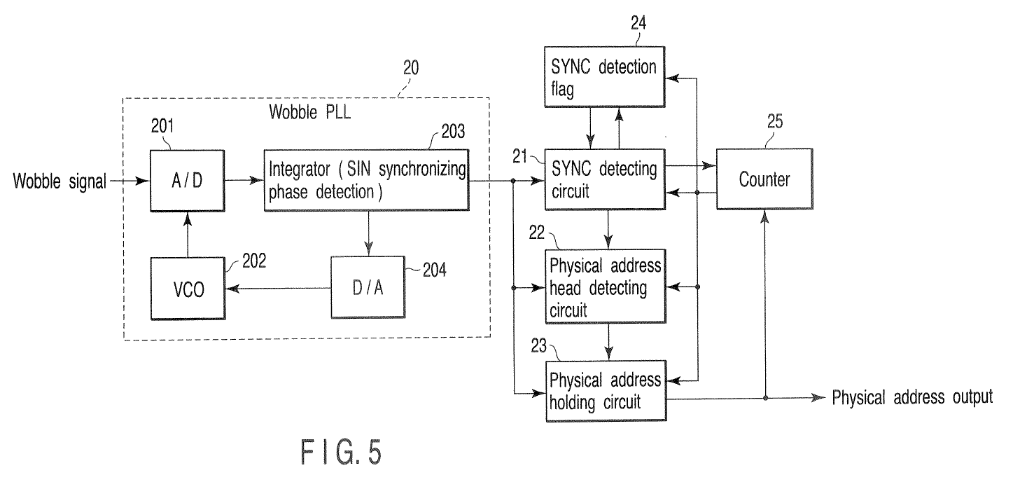

FIG. 5 is a block diagram showing the internal configuration of a physical address detecting device 5 according to the present invention. This device is roughly divided into a wobble PLL circuit 20, a SYNC detecting circuit 21, a physical address head detecting circuit 22, a physical address holding circuit 23, a SYNC detection flag circuit 24, and a counter circuit 25.

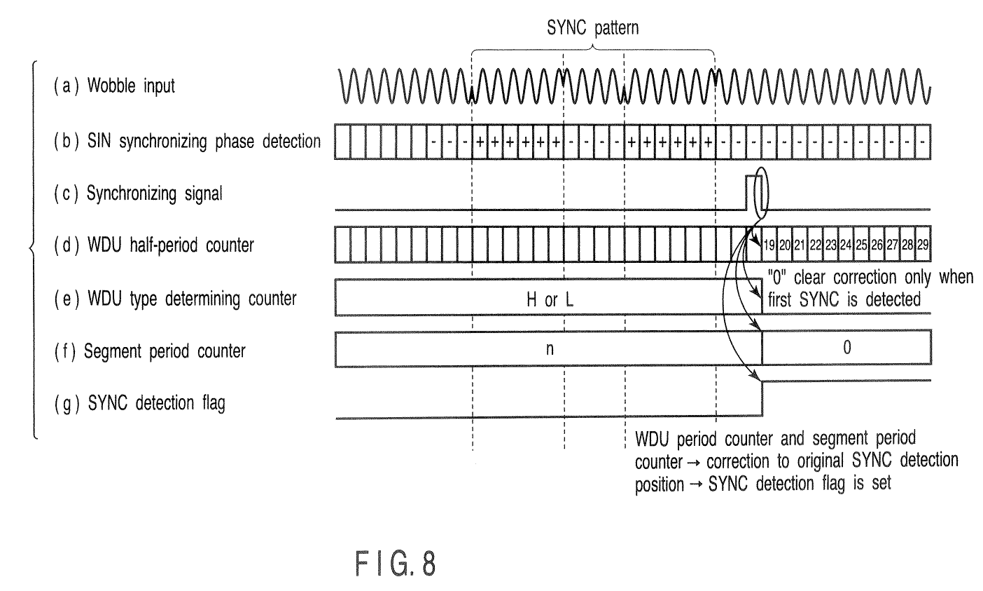

The wobble PLL circuit 20 integrates a wobble input signal, a reference SIN wave, and a reference COS wave. The wobble PLL circuit 20 has an A/D converter 201 that subjects a wobble signal to an analog/digital conversion to obtain a digital signal. A digitalizing clock is provided by a voltage control oscillator (VCO) 202. The digitalized wobble signal is input to an integrator 203, which then converts the signal into bit information (“1” or “0”). The relationship between the input wobble signal and a detection signal (also referred to as a SYN synchronizing phase signal) is as shown below as a wobble input (a) in FIG. 8 and a SIN synchronizing phase signal (b) in FIG. 8. Outputs from the integrator 203 are SIN synchronizing phase detection data which is the integration of the wobble signal and the reference SIN wave and which is input to the SYNC detecting circuit 21 and COS synchronizing phase detection data which is the integration of the wobble signal and the reference COS wave and which is input to a digital/analog (D/A) converter 204. The resulting analog signal is used as a control signal for VCO 202. This sets the PLL circuit 20 so that the circuit is locked to the SIN phase of the wobble signal.

The SIN synchronizing phase signal is input to the SYNC detecting circuit 21, physical address head detecting circuit 22, and physical address holding circuit 23. An IPW portion of the SIN synchronizing phase signal is output as a “+” value, and NPW is output as a “−” value. A SYNC pattern and a physical address pattern are detected in the SIN synchronizing phase signal.

The SYNC detecting circuit 21 detects a synchronizing signal (SYNC) located at the head of the segments shown in FIG. 3. The physical address head detecting circuit 22 detects the leading position of the data forming a physical address contained in each WDU. The physical address holding circuit 23 holds a detected physical address. The counter section 25 uses a clock generated by the wobble PLL circuit 20 to generate timings for each WDU, WAP (physical segment), data segment in conformity with the standards shown in FIG. 3.

The physical address head detecting section 22 and physical address holding section 23 are circuits that correctly detect a 4 IPW wobble portion inherent in a physical address area leading pattern, in every 84 wobbles in predetermined physical address positions (“1st” to “11th” WAPs in FIG. 3). The head of a physical address can be detected if an appropriate signal status is detected (the code matches) and if an edge detection value is equal to or more than thresholds, as is the case with SYNC. The sets each of four wobbles following the physical address head (4 IPW wobbles) are added together. The resulting code is then held to detect the physical address.

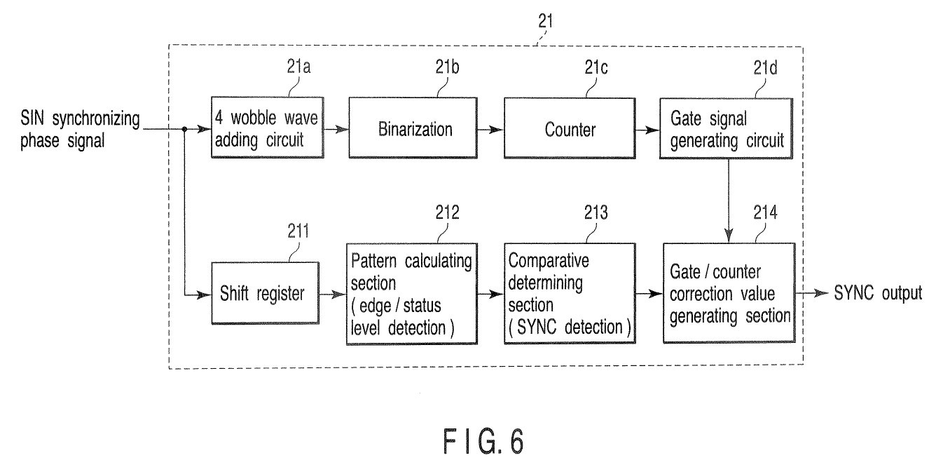

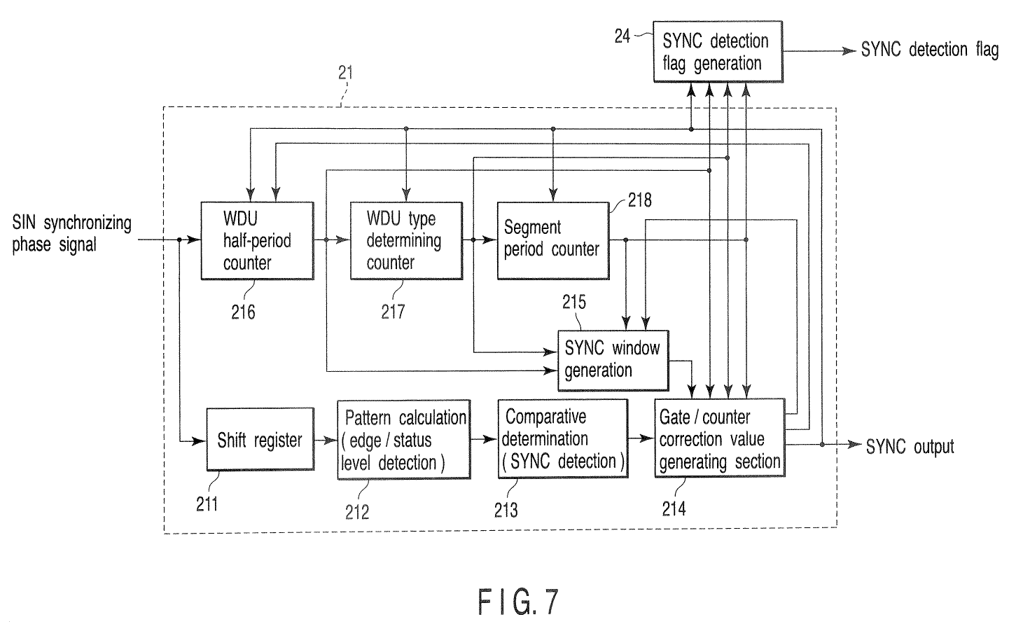

FIG. 6 shows an exemplary configuration of the SYNC detection circuit 21 exhibiting a high detection accuracy. FIG. 7 is an exemplary basic SYNC detecting circuit. In FIG. 6, the SIN synchronizing phase signal is shifted by a shift register 211. The processing result is input to a pattern calculating section 212. The pattern calculating section 212 executes a differential calculation for code change points (IPW→NPW/NPW→IPW: edge detection) of the shifted signal and compares codes for the parts of the signal other than the edge change points to detect status stability (code match).

A comparative determining section 213 outputs a synchronizing signal detection signal if the edge detection value is equal to or more than a threshold and if the comparative determining section 213 can detect that the status matches that in SYNC. This signal is input to a gate/counter correction value generating section (for example, an AND circuit) 214. When the detection signal from the comparative determining section 213 is input to the gate/counter correction value generating section 214 and if the gate/counter correction value generating section 214 is already provided with a window signal from a gate signal generating circuit 21d, the gate/counter correction value generating section 214 provides a SYNC output.

A 4 wobble wave adding circuit 21a executes a 4 wobble wave addition that is the maximum change unit common to the SYNC and physical address signals. The four wobble waves correspond to a modulation code bit clock unit common to the SYNC and physical address signals. The four wobble waves have their status changed every four waves and offer the highest detection efficiency.

With the addition of every four wobbles, even if one of the waves is modified by noise or the like, the normal result for the remaining three waves is predominant in the addition of the four waves. This prevents misdetections. If the four waves contain the same numbers of plus and minus signs as in the case of, for example, “++−−”, the addition of the four waves is indefinite. However, this part often corresponds to a change point where the wobble waveform changes from IPW to NPW or from NPW to IPW. Consequently, indefinite addition infrequently occurs in the other parts.

The 4 wave addition is binarized by a binarizing circuit 21b, and a counter 21c counts up the addition. The non-modulation area (unity field) precedes the SYNC area as shown in FIG. 3. This enables the SYNC area to be predicted. A gate signal generating section 21d can thus generate a gate signal (window signal) on the basis of the counter value.

FIG. 7 shows the interior of the basic SYNC detecting circuit 21. The SYNC detecting circuit 21 detects a (six IPW wobbles+four NPW wobbles+six IPW wobbles) part inherent in the SYNC pattern, in an 84-wobble signal for a predetermined SYNC pattern position (“0”th WAP in FIG. 3).

As shown in FIG. 7, the SIN synchronizing phase signal is first shifted by the shift register 211 and input to the pattern calculating section 212. The pattern calculating section 212 executes a differential calculation for code change points (IPW→NPW/NPW→IPW: edge detection) of the shifted signal and compares codes for the parts of the signal other than the edge change points to detect status stability (code match).

The comparative determining section 213 outputs a synchronizing signal detection signal if the edge detection value is equal to or more than a threshold and if the comparative determining section 213 can detect that the status matches that in SYNC. This signal is input to the gate/counter correction value generating section 214. When the detection signal from the comparative determining section 213 is input to the gate/counter correction value generating section 214 and if the gate/counter correction value generating section 214 is already provided with a window signal from a SYNC window generating section 215, the gate/counter correction value generating section 214 provides a SYNC output.

The SIN synchronizing phase signal is also input to a WDU half-period counter 216. The WDU half-period counter 216 counts up a wobble clock (SIN synchronizing phase signal) and executes the clock counting using the half period of WDU as a cycle period. Since WDU is composed of 84 wobbles, the half period counter can be implemented when an 84 count value corresponds to one period (first period) of WDU and when wobble clocks 0 to 41 correspond to one period.

A WDU type determining counter 217 counts carries in the half period counter 216. An output from the type determining counter 217 is 1 bit and alternately outputs “1” and “0” every time the half-period counter 217 produces a carry. As a result, the output from the type determining counter 302 indicates WDU as “1” or “0” every half period. The interval between outputs “1” and “1” from the type determining counter 302 indicates one period of WDU.

A segment period counter 218 succeeding the WDU type determining counter 217 counts up for each WDU and has a cycle period equal to one WAP (second period). As also shown in FIG. 3, each of the primary and secondary segment types is composed of 17 WDUs. The segment period counter 218 repeatedly counts 17 WDUs from 0 to 16.

The WDU half-period counter 216, WDU type determining counter 217, and segment period counter 218 count up using the head of segments as a reference. Consequently, these three types of counter outputs enable the determination of each of bit positions of a physical address contained in the segments.

The following are input to the SYNC window generating section 215: outputs from the WDU half-period counter 216, WDU type determining counter 217, and segment period counter 218 as well as a SYNC output. The SYNC window generating section 215 logically determines the input signal and generates a gate signal at the position of the SYNC output. The SYNC window generating section 215 provides the gate signal to the gate/counter correction value generating section 214.

Once SYNC detection occurs, a SYNC detection flag is set. Subsequent SYNC detections are based on a flywheel counter.

In this case, various counters are corrected on the basis of SYNC detections as required.

The WDU half-period counter 216 and WDU type determining counter 217 have a period of one WDU (84 wobbles); the WDU half-period counter 216 counts the half (42 wobbles) of one WDU period (84 wobbles), while the WDU type determining counter 217 counts carries. The reason is as follows. With the two WDU types (primary and secondary segments), if the WDU type determining counter 217 is corrected by assigning the WDU type to it, only 1 bit in the WDU type determining counter 217 is corrected. Accordingly, compared to a WDU period counter (1 WDU period), the two separate counters (WDU half-period counter 216 and WDU type determining counter 217) are very effective.

For the assignment of the WDU type, the primary segment type is assigned when the output from the WDU type determining counter=“0”. The secondary segment type is assigned when the output from the WDU type determining counter=“1”. The segment period counter 218 counts 1 WAP periods; it counts carries in the WDU type determining counter 217 (17 WDUs).

FIG. 8 shows operation timings for each section of the above SYNC detecting circuit 21. FIG. 8(a) shows a wobble signal, a SYNC portion and portions preceding and succeeding the SYNC portion. FIG. 8(b) shows a SIN synchronizing phase signal. FIG. 8(c) shows a synchronizing signal (SYNC). FIGS. 8(d), 8(e), 8(f), and 8(g) show outputs from the WDU half-period counter 216, WDU type determining counter 217, and segment period counter 218, and the SYNC detection flag, respectively.

In the present device, one SYNC detection flag is provided for a characteristic element; the SYNC detection flag is output by the SYNC detection flag circuit 24.

The physical address area head detecting section 22 and physical address holding section 23 are circuits which correctly detect the 4 IPW wobble portion inherent in the physical address area leading pattern, in every 84 wobbles in the predetermined physical address positions (“1”st to “11”th WAPs in FIG. 3) and which detect a succeeding physical address.

The head of a physical address can be detected if an appropriate signal status is detected (the code matches) and if the edge detection value is equal to or more than a threshold as is the case with SYNC. The sets each of four wobbles following the physical address head (4 IPW wobbles) are added together. The resulting code is then held to detect the physical address.

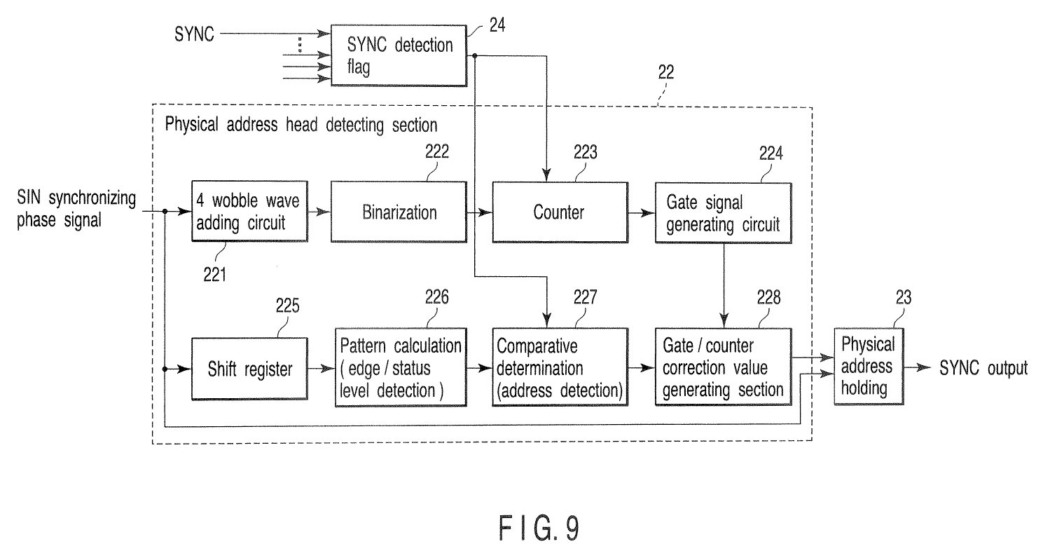

FIG. 9 shows an exemplary configuration of the physical address head detecting section 22. The physical address head detecting section 22 is also provided with the SYNC detection flag from the SYNC detection flag circuit 24. The circuit 24 outputs a flag indicating that SYNC detection has occurred (active=1).

The SIN synchronizing phase signal is input to a 4 wobble wave adding circuit 221. The 4 wobble wave adding circuit 221 executes a 4 wobble wave addition that is the maximum change unit common to the SYNC and physical address signals. The 4 wave addition is binarized by a binarizing circuit 222, and a counter 223 counts up the addition. This makes it possible to correctly detect a timing for the 4 IPW wobble portion inherent in the physical address area leading pattern, in every 84 wobbles in the predetermined physical address positions (“1” st to “11” th WAPs in FIG. 3). A gate signal generating section 224 can generate a gate signal (window signal) corresponding to the head of address information on the basis of the counter value in the counter 223.

On the other hand, the SIN synchronizing phase signal is shifted by a shift register 225. The processing result is then input to a pattern calculating section 226. The pattern calculating section 226 executes a differential calculation for code change points (IPW→NPW/NPW→IPW: edge detection) of the shifted signal and compares codes for the parts of the signal other than the edge change points to detect status stability (code match).

Upon detecting that the edge detection value is equal to or more than the threshold and that the status matches that of the head of the address information (for example, the SIN synchronizing phase signal can be determined to be “++−−”), the comparative determining section 227 outputs a detection signal for the address information head. Of course, in this case, the synchronicity detection flag has been set. The detection signal is input to an AND circuit 228. When the detection signal from the comparative determining section 213 is input to the AND circuit 228 and if the AND circuit 228 is already provided with a window signal from the gate signal generating circuit 224, the AND circuit 228 outputs and provides an address information head detection signal to the physical address holding circuit 23.

The physical address holding circuit 23 loads and holds a SIN synchronizing phase signal succeeding the address information head detection signal. Thus, every 3 bits of physical address information can be acquired from each WDU to constitute physical address information for one segment.

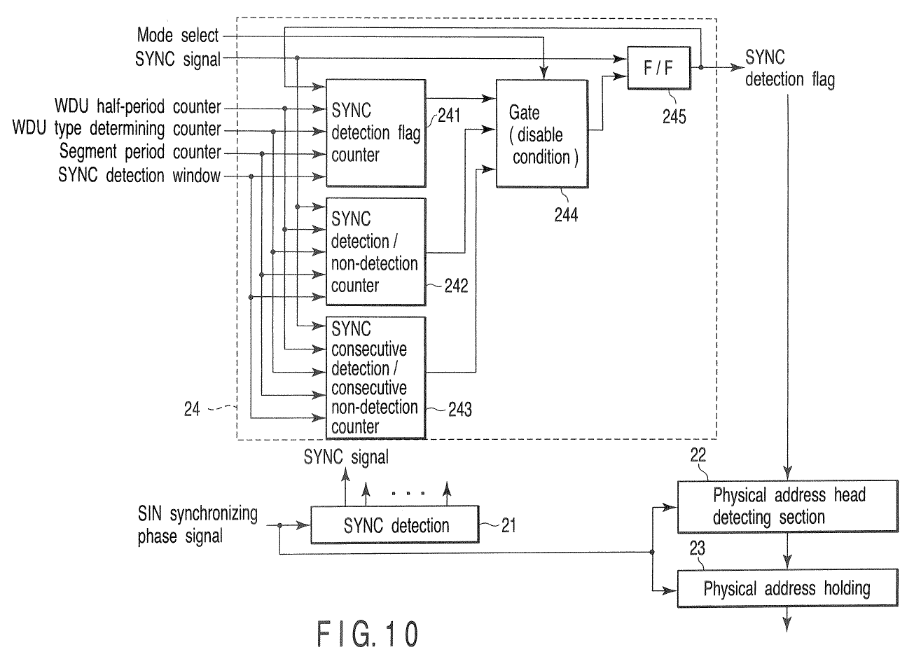

FIG. 10 specifically shows the configuration of the SYNC detection flag circuit 24. This circuit has a SYNC detection flag counter 241, a SYNC detection/non-detection counter 242, a SYNC consecutive detection/consecutive non-detection counter 243, a gate circuit 244, and a flip flop circuit 245 serving as a synchronicity detection flag generating section. When a SYNC signal (or an output from the circuit shown in FIG. 6 or 7) is input to one end of the flip flop circuit 245, the SYNC detection flag is set. The SYNC signal may be generated for each WAP (each segment) on the basis of SYNC detections using the flywheel counter.

The SYNC detection flag counter 241 monitors the output status of the SYNC detection flag. The SYNC detection/non-detection counter 242 monitors the number of SYNC detections and the number of SYNC non-detections. The SYNC consecutive detection/consecutive non-detection counter 243 monitors the number of consecutive SYNC detections and the number of consecutive SYNC non-detections. The gate circuit 244 logically determines each counter output, and depending on the determination, resets the flip flop circuit 245. Further, a mode select signal enables reset conditions for the SYNC detection flag to be controllably switched. The above circuits 241 to 244 constitute a counter and logic determining section.

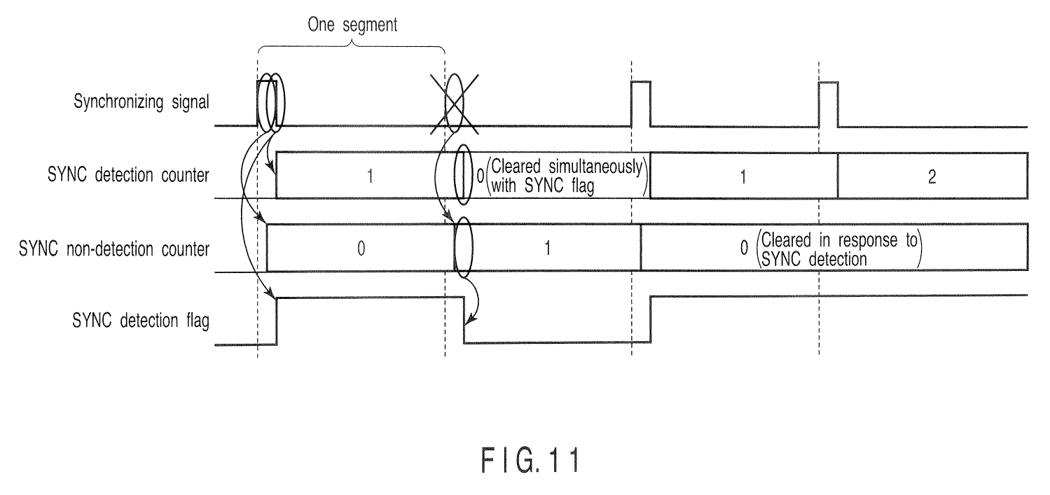

The SYNC detection flag is set for each SYNC detection, and various timings are used to reset the SYNC detection flag depending on the conditions. This will be described below in detail with reference to FIGS. 11 to 15.

The timing chart shown in FIG. 8 shows a timing for setting the SYNC detection flag in response to the first SYNC detection. The first SYNC detection clears the WDU type determining counter 217 to zero. The WDU period counter 216 and segment period counter 218 correct predetermined values to the original SYNC detection position. In this case, the SYNC detection flag is also set.

FIG. 11 shows timings when the SYNC detection flag is set by the first SYNC detection as described with reference to FIG. 8 and is reset by one SYNC non-detection that occurs in the next segment. This is effective, for example, for power-on of the apparatus or for resynchronization based on SYNC detection after resetting of the SYNC detection flag. Settings may be made such that for a certain period of time after power-on, a mode selector allows the gate circuit 244 to make such logic determinations as shown in FIG. 11.

The first SYNC detection does not depend on the flywheel counter but consists only of the SYNC pattern detection. Accordingly, to maintain reliability, the SYNC detection flag is reset if the SYNC signal is not detected in the next segment. In the figure, the SYNC detection counter=“0” and the SYNC non-detection counter=“1”. The SYNC detecting operation succeeding the first SYNC detection is determined to fail to reset the SYNC detection flag. In this example, the SYNC detection or non-detection is determined using the counters. However, any method may be used to determine the numbers of consecutive SYNC detections/non-detections.

Although not shown in the drawings, when the physical address succeeding the SYNC signal is detected and determined to be correct through a CRC check, even if SYNC non-detection occurs in the next segment, the device may determine that the period specified in the physical standards shown in FIG. 3 is satisfied. Thus, the SYNC detection flag may not be reset. Also in this case, the mode selector may control the reset conditions for allowing the gate circuit 244 to reset the SYNC detection flag.

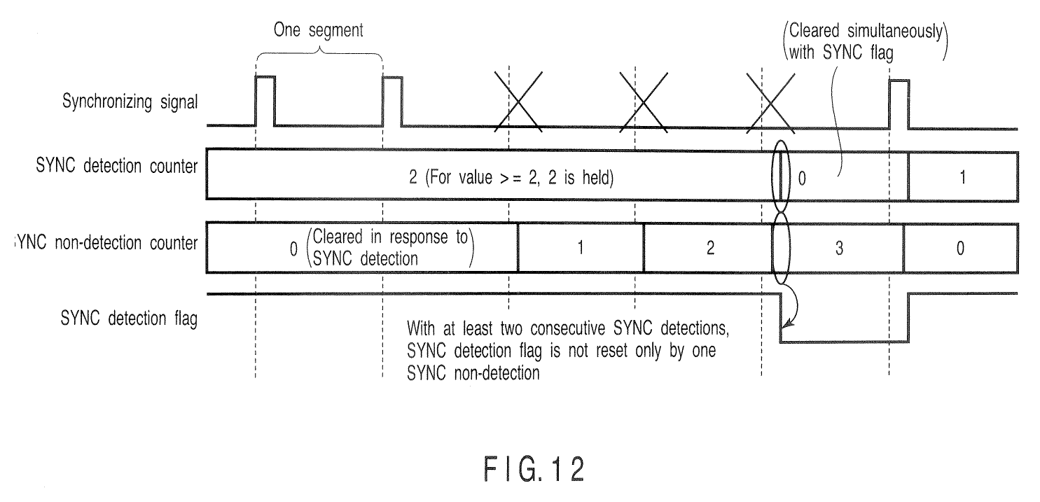

FIG. 12 shows a timing at which the SYNC detection flag is reset if the SYNC signal is consecutively detected at least twice and is subsequently not detected plural consecutive times (for example, not detected in three segments). If the SYNC signal is consecutively detected at least twice, the SYNC detection is based on the SYNC pattern detection using the flywheel counter. Accordingly, the 1 WAP (1 segment) unit shown in FIG. 3 is met to improve reliability. Thus, if the SYNC signal is consecutively detected at least twice, the SYNC detection is not immediately reset but is reset if the SYNC signal is subsequently not detected in plural consecutive segments.

In FIG. 12, when the SYNC detection counter=“2” (since the consecutive detection is monitored, the value “2” is held for the subsequent detections) and the SYNC non-detection counter=“3”, the device determines that three consecutive non-detections occur after at least two consecutive SYNC detections. In this example, the SYNC detection flag is reset in the case of three consecutive SYNC non-detections. However, the number of consecutive non-detections is arbitrary. Even if the SYNC signal cannot be detected (less than three SYNC non-detections), when a physical address is detected, its head can be detected. This enables a more reliable physical address to be very effectively detected.

Although not shown in the drawings, when the physical address succeeding the SYNC signal is detected and determined to be correct through a CRC check or when the consecutiveness (+1 increment) of the address is determined on the basis of the preceding and succeeding physical addresses, even if SYNC non-detection occurs in the next segment, the device may determine that the period specified in the physical standards shown in FIG. 3 is satisfied. Thus, the SYNC detection flag may not be reset.

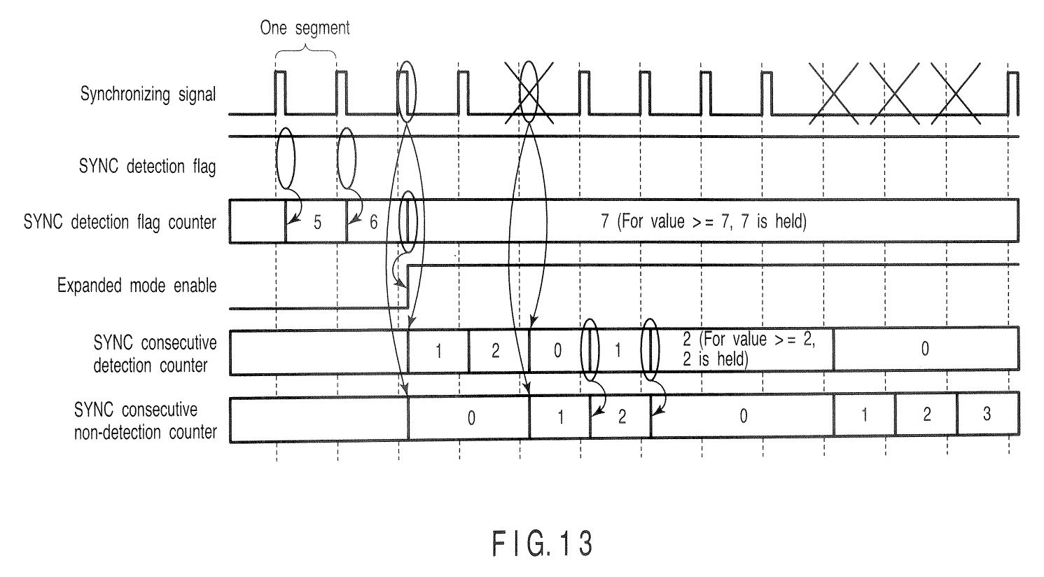

FIG. 13 shows a timing at which an expanded operation mode for the SYNC detection flag is set which, if a more reliable status remains, avoids resetting the SYNC detection flag more strictly than the method for resetting the flag in response to SYNC non-detections as shown in FIG. 12. If d consecutive SYNC signals (d: arbitrary; in the figure, seven) are detected to set the SYNC detection flag, the 1 WAP (1 segment) shown in FIG. 3 is satisfied, further improving reliability. In this case, in the expanded mode, the SYNC detection flag may not be reset only by three consecutive SYNC non-detections as shown in FIG. 12.

FIG. 13 shows that the SYNC detection flag counter 241 (=“7”) detects that the SYNC detection flag has been set seven consecutive times. In this case, an expansion mode enable signal changes to a high level to bring the device into the expanded mode. In this mode, the SYNC detection flag may not be reset only by one SYNC non-detection, three consecutive SYNC non-detections, or the like as shown in FIGS. 11 and 12.

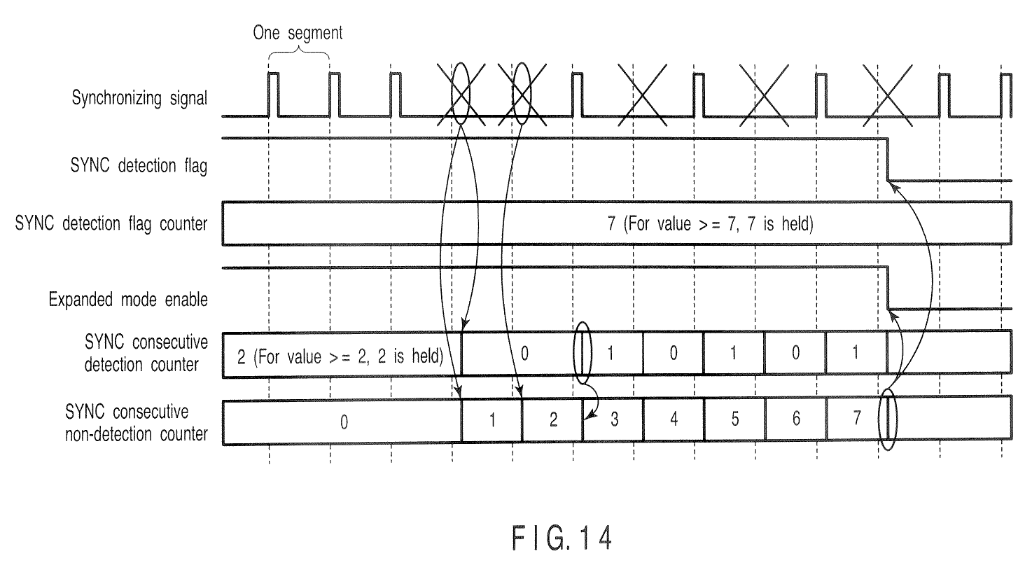

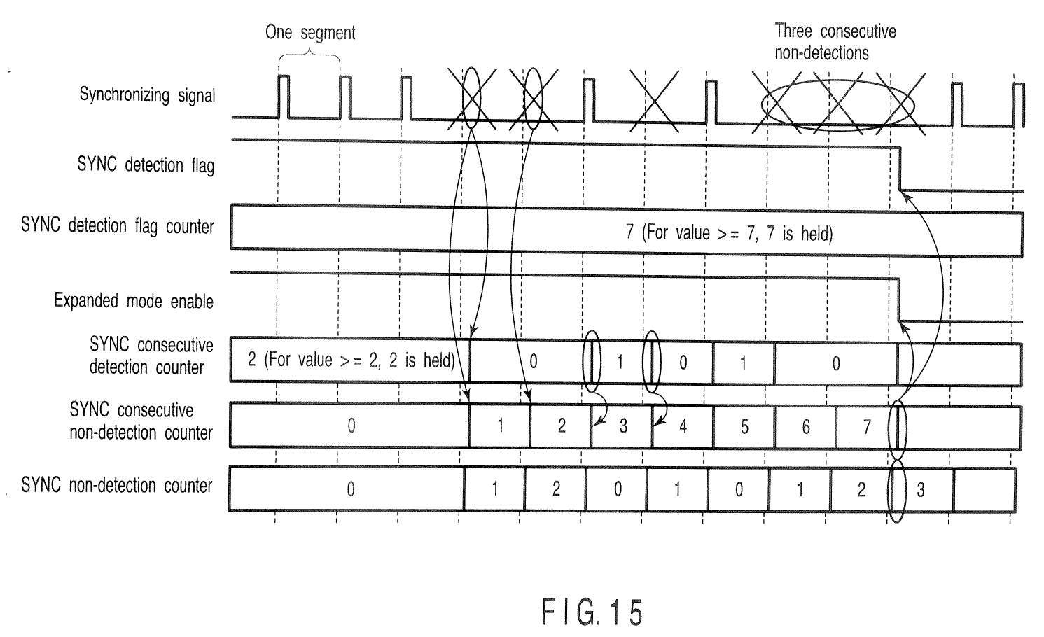

With reference to FIGS. 14 and 15, a detailed description will be given of the case in which the SYNC detection flag is reset. FIG. 14 shows the status in the expanded mode. In the expanded mode, the device checks whether or not any consecutive SYNC detections are more reliable on the basis of the past c (c is an integer) SYNC detections.

Here, if e (e: arbitrary) SYNC non-detections occur (e consecutive SYNC signals are not detected) in the expanded mode, the SYNC detection flag is reset. In the example in FIG. 14, the number of past references c is set at “7”, and the number of consecutive SYNC detections e is set at “2”. That is to say, two consecutive SYNC non-detections cause the SYNC consecutive non-detection counter to count up.

In the expanded enable status, the SYNC consecutive detection counter repeats 0, 1, 0, 1 (two consecutive SYNC non-detections). The SYNC signal changes from three consecutive detections through two consecutive non-detections, one detection, one non-detection, one detection, one non-detection, one detection, and one non-detection to two consecutive detections. In other words, two consecutive SYNC non-detections occur for seven consecutive periods (seven consecutive times). This disables the expanded mode to reset the SYNC detection flag.

FIG. 15 shows an example in which the conditions in FIGS. 14 and 12 are simultaneously met. The figure shows that when consecutive SYNC detections have not occurred for the past c periods and the SYNC detection has not occurred for consecutive periods, the SYNC detection flag is reset. In the figure, as is the case with FIG. 13, the number of past references is set at “7” and the number of consecutive non-detections is set at “3”. Thus, when the SYNC consecutive non-detection counter=“7” and the SYNC non-detection counter=“3” are simultaneously established, the SYNC detection flag is reset.

As described above, the present invention basically handles a format of information incorporated into information recording media by subjecting recording tracks in the information recording media to wobble modulation; the format has at least physical segments, each which is partitioned into recording tracks, a wobble data unit (WDU) for a synchronizing signal which is contained in a head of the physical segments, a wobble data unit (WDU) for a non-modulation section which is contained in a latter half of the physical segments, and a wobble data unit (WDU) for a physical address which is contained in an intermediate area of the physical segments. As shown in FIG. 10, a wobble signal reproduced from the recording track is input to the synchronicity detecting circuit 21, which detects the synchronizing signal in the wobble signal. The synchronicity detection flag generating circuit 245 generates a synchronicity detection flag of a first level when the synchronicity detecting circuit detects the synchronizing signal. The counter and logic determining section 241 to 245 reset the synchronicity detection flag to a second level when the output synchronicity detection flag of the first level remains active and when the number of non-detections of the synchronizing signal meets a predetermined condition. As shown in FIG. 11, the counter and logic determining section 241 to 244 includes the detection counter which counts detections of the synchronizing signal and the non-detection counter which counts non-detections of the synchronizing signal. When the detection counter indicates 1 and the non-detection counter indicates 0 at the first synchronicity detection timing and the detection counter indicates 1 and the non-detection counter indicates 0 at the next synchronicity detection timing, the synchronicity detection flag is reset. Alternatively, as shown in FIG. 12, the counter and logic determining section 241 to 244 includes the detection counter which counts detections of the synchronizing signal and the non-detection counter which counts non-detections of the synchronizing signal. If the detection counter counts a predetermined number a (a is an integer), when the non-detection counter indicates a predetermined number b (b is an integer), the synchronicity detection flag can be reset.

Alternatively, as shown in FIGS. 13 and 14, the counter and logic determining section (241 to 244) includes the detection counter which counts detections of the synchronizing signal, the non-detection counter which counts non-detections of the synchronizing signal, the consecutive detection counter which counts consecutive detections of the synchronizing signal, the consecutive non-detection counter which counts consecutive non-detections of the synchronizing signal, and the synchronicity detection flag counter which counts the synchronicity detection flag which is set when the synchronizing signal is detected.

When the synchronicity detection flag counter indicates a predetermined value d (d is an integer), the synchronicity detection flag status is maintained even though the non-detection counter indicates the predetermined value b (b is an integer). When the count in the synchronizing signal consecutive non-detection counter becomes a predetermined value c (c is an integer), the synchronicity detection flag is reset.

Alternatively, as shown in FIG. 15, the counter and logic determining section (241 to 244) includes the detection counter which counts detections of the synchronizing signal, the non-detection counter which counts non-detections of the synchronizing signal, the consecutive detection counter which counts consecutive detections of the synchronizing signal, the consecutive non-detection counter which counts consecutive non-detections of the synchronizing signal, and the synchronicity detection flag counter which counts the synchronicity detection flag which is set when the synchronizing signal is detected. When the synchronicity detection flag counter indicates the predetermined value d (d is an integer), the synchronicity detection flag status is maintained even though the non-detection counter indicates the predetermined value b (b is an integer). When both the following conditions are simultaneously met: a count in the synchronizing signal consecutive non-detection counter becomes the predetermined value c (c is an integer) and a count in the non-detection counter becomes the predetermined value b (b is an integer), the synchronicity detection flag is reset.

The use of the SYNC detection flag exerts the following effects. In the second and subsequent SYNC detections, the accuracy of the SYNC detection is improved. In particular, in HD DVD-R, adjacent tracks are likely to affect each other, so that appropriate measures need to be taken for preventing the wobble signal from being mixed. To take appropriate measures, it is necessary to predetermine the SYNC and physical address positions. In this case, the set SYNC detection flag allows the appropriate measures to be easily taken because the SYNC pattern is aligned with the flywheel counter.

Specifically, in HD DVD-R, the physical address area includes 11 WDUs, allowing the WDU position to be easily determined using the flywheel counter with the SYNC detection flag set. HD DVD-R also involves different types of SYNC signals and physical addresses. This enables the type to be predetermined using the flywheel counter with the SYNC detection flag set. Conventional type determination involves a check with a type bit after the determination of a physical address. However, the set SYNC detection flag indicates the high reliability of the physical address. Accordingly, direct type determination may be made before the determination of the physical address.

For wobble PLL lock determination, PLL lock determination with the code portion (IPW) pre-excluded can be made using the flywheel counter with the SYNC detection flag set. This enables PLL lock determination to be quickly made.

While certain embodiments of the invention have been described, these embodiments have been presented by way of example only, and are not intended to limit the scope of the invention. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A synchronicity determining device in which a format of information incorporated into information recording media by subjecting recording tracks in the information recording media to wobble modulation has at least physical segments, each which is partitioned into recording tracks, a wobble data unit for a synchronizing signal which is contained in a head of the physical segments, a wobble data unit for a non-modulation section which is contained in a latter half of the physical segments, and a wobble data unit for a physical address which is contained in an intermediate area of the physical segments, the device comprising:
a synchronicity detecting circuit to which a wobble signal reproduced from the recording track is input and which detects the synchronizing signal in the wobble signal;
a synchronicity detection flag generating circuit which generates a synchronicity detection flag of a first level when the synchronicity detecting circuit detects the synchronizing signal; and
a counter and logic determining section which resets the synchronicity detection flag to a second level when the output synchronicity detection flag of the first level remains active and when the number of non-detections of the synchronizing signal meets a predetermined condition.

2. The synchronicity determining device according to claim 1, wherein the counter and logic determining section includes a detection counter which counts detections of the synchronizing signal and a non-detection counter which counts non-detections of the synchronizing signal, and
when the detection counter indicates 1 and the non-detection counter indicates 0 at a first synchronicity detection timing and the detection counter indicates 1 and the non-detection counter indicates 0 at a next synchronicity detection timing, the synchronicity detection flag is reset.

3. The synchronicity determining device according to claim 1, wherein the counter and logic determining section includes a detection counter which counts detections of the synchronizing signal and a non-detection counter which counts non-detections of the synchronizing signal, and if the detection counter counts a predetermined number a (a is an integer), when the non-detection counter indicates a predetermined number b (b is an integer), the synchronicity detection flag is reset.

4. The synchronicity determining device according to claim 1, wherein the counter and logic determining section includes a detection counter which counts detections of the synchronizing signal, a non-detection counter which counts non-detections of the synchronizing signal, a consecutive detection counter which counts consecutive detections of the synchronizing signal, a consecutive non-detection counter which counts consecutive non-detections of the synchronizing signal, and a synchronicity detection flag counter which counts the synchronicity detection flag which is set when the synchronizing signal is detected, and
when the synchronicity detection flag counter indicates a predetermined value d (d is an integer), the synchronicity detection flag status is maintained even though the non-detection counter indicates a predetermined value b (b is an integer), and when a count in the synchronizing signal consecutive non-detection counter becomes a predetermined value c (c is an integer), the synchronicity detection flag is reset.

5. The synchronicity determining device according to claim 1, wherein the counter and logic determining section includes a detection counter which counts detections of the synchronizing signal, a non-detection counter which counts non-detections of the synchronizing signal, a consecutive detection counter which counts consecutive detections of the synchronizing signal, a consecutive non-detection counter which counts consecutive non-detections of the synchronizing signal, and a synchronicity detection flag counter which counts the synchronicity detection flag which is set when the synchronizing signal is detected, and
when the synchronicity detection flag counter indicates a predetermined value d (d is an integer), the synchronicity detection flag status is maintained even though the non-detection counter indicates a predetermined value b (b is an integer), and when both the following conditions are simultaneously met: a count in the synchronizing signal consecutive non-detection counter becomes a predetermined value c (c is an integer) and a count in the non-detection counter becomes a predetermined value b (b is an integer), the synchronicity detection flag is reset.

6. A physical address detecting device in which a format of information incorporated into information recording media by subjecting recording tracks in the information recording media to wobble modulation has at least physical segments each of which is partitioned into recording tracks, a wobble data unit for a synchronizing signal which is contained in a head of the physical segments, a wobble data unit for a non-modulation section which is contained in a latter half of the physical segments, and a wobble data unit for a physical address which is contained in an intermediate area of the physical segments, the device comprising:
a synchronicity detecting circuit to which a wobble signal reproduced from the recording track is input and which detects the synchronizing signal in the wobble signal;
a synchronicity detection flag generating circuit which generates a synchronicity detection flag of a first level when the synchronicity detecting circuit detects the synchronizing signal;
a counter and logic determining section which resets the synchronicity detection flag to a second level when the output synchronicity detection flag of the first level remains active and when the number of non-detections of the synchronizing signal meets a predetermined condition; and
a physical address extracting section which extracts the physical address when the synchronicity detection flag of the first level is being input.

7. A method for detecting a physical address in which a format of information incorporated into information recording media by subjecting recording tracks in the information recording media to wobble modulation has at least physical segments, each of which is partitioned into recording tracks, a wobble data unit for a synchronizing signal which is contained in a head of the physical segments, a wobble data unit for a non-modulation section which is contained in a latter half of the physical segments, and a wobble data unit for a physical address which is contained in an intermediate area of the physical segments, the method comprising:
inputting a wobble signal reproduced from the recording track, to a synchronicity detecting circuit, which then detects the synchronizing signal in the wobble signal;
allowing a synchronicity detection flag generating circuit to generate a synchronicity detection flag of a first level in response to the detected synchronizing signal;
allowing a counter and logic determining section to reset the synchronicity detection flag to a second level when the output synchronicity detection flag of the first level remains active and when the number of non-detections of the synchronizing signal meets a predetermined condition; and
allowing a physical address extracting section to extract the physical address when the synchronicity detection flag of the first level is being input.

8. The method for detecting a physical address according to claim 7, wherein the counter and logic determining section includes a detection counter which counts detections of the synchronizing signal and a non-detection counter which counts non-detections of the synchronizing signal, and
when the detection counter indicates 1 and the non-detection counter indicates 0 at a first synchronicity detection timing and the detection counter indicates 1 and the non-detection counter indicates 0 at a next synchronicity detection timing, the synchronicity detection flag is reset.

9. The method for detecting a physical address according to claim 7, wherein the counter and logic determining section includes a detection counter which counts detections of the synchronizing signal, a non-detection counter which counts non-detections of the synchronizing signal, and a synchronicity detection flag counter which counts the synchronicity detection flag which is set when the synchronizing signal is detected, and
if the detection counter counts a predetermined number a (a is an integer), when the non-detection counter indicates a predetermined number b (b is an integer), the synchronicity detection flag is reset.

10. The method for detecting a physical address according to claim 7, wherein the counter and logic determining section includes a detection counter which counts detections of the synchronizing signal, a non-detection counter which counts non-detections of the synchronizing signal, a consecutive detection counter which counts consecutive detections of the synchronizing signal, a consecutive non-detection counter which counts consecutive non-detections of the synchronizing signal, and a synchronicity detection flag counter which counts the synchronicity detection flag which is set when the synchronizing signal is detected, and
when the synchronicity detection flag counter indicates a predetermined value d (d is an integer), the synchronicity detection flag status is maintained even though the non-detection counter indicates a predetermined value b (b is an integer), and when a count in the synchronizing signal consecutive non-detection counter becomes a predetermined value c (c is an integer), the synchronicity detection flag is reset.

11. The method for detecting a physical address according to claim 7, wherein the counter and logic determining section includes a detection counter which counts detections of the synchronizing signal, a non-detection counter which counts non-detections of the synchronizing signal, a consecutive detection counter which counts consecutive detections of the synchronizing signal, a consecutive non-detection counter which counts consecutive non-detections of the synchronizing signal, and a synchronicity detection flag counter which counts the synchronicity detection flag which is set when the synchronizing signal is detected, and
when the synchronicity detection flag counter indicates a predetermined value d (d is an integer), the synchronicity detection flag status is maintained even though the non-detection counter indicates a predetermined value b (b is an integer), and when both the following conditions are simultaneously met: a count in the synchronizing signal consecutive non-detection counter becomes a predetermined value c (c is an integer) and a count in the non-detection counter becomes a predetermined value b (b is an integer), the synchronicity detection flag is reset.
